(19) United States
(12) Patent Application Publication
(10) Pub. No.: US 2015/0205721 A1
(43) Pub. Date: Jul. 23, 2015

(54) Handling Reads Following Transactional Writes during Transactions in a Computing Device

(71) Applicant: Advanced Micro Devices, Inc., Sunnyvale, CA (US)

(72) Inventors: Stephan Diestelhorst, Dresden (DE); Martin T. Pohlack, Dresden (DE); Michael P. Hohmuth, Dresden (DE)

(73) Assignee: Advanced Micro Devices, Inc., Sunnyvale, CA (US)

(21) Appl. No.: 14/160,552

(22) Filed: Jan. 22, 2014

(51) Int. Cl. G06F 12/08; G06F 9/46

(52) U.S. Cl. CPC G06F 12/0811; G06F 9/467

(57) ABSTRACT

The described embodiments include a computing device that handles cache blocks during a transaction. In the described embodiments, after an entity has written to a cache block in a cache during the transaction, the computing device responds to a read request for the cache block from another entity with a copy of the cache block in a pre-transactional state. In these embodiments, the entity executing the transaction continues the transaction after the computing device responds to the read request from the other entity.

### BACKGROUND

1. Field

The described embodiments relate to computing devices. More specifically, the described embodiments relate to handling reads following transactional writes during transactions in computing devices.

2. Related Art

Some computing devices support “hardware transactional memory.” In these computing devices, hardware transactional memory is implemented by enabling entities (processors, cores, threads, and/or other portions of the computing device) to execute sections of program code in “transactions,” during which program code is executed normally, but transactional operations/results are prevented from being made accessible to and usable by other entities on the computing device. For example, memory reads and writes are allowed during transactions, but transactional memory writes may be prevented from being committed to one or more levels of a memory hierarchy in the computing device during the transaction, thereby rendering the written data inaccessible by other entities in the computing device. During transactions, memory accesses from other entities are monitored to determine if a memory access from another entity interferes with a transactional memory access (e.g., if another of the entities writes data to a memory location read during the transaction, etc.) and transactional operations are monitored to ensure that an error condition has not occurred. If an interfering memory access or an error condition is encountered during the transaction, the transaction is aborted, a pre-transactional state of the entity is restored, and the entity may retry the transaction by re-executing the section of program code in another transaction and/or some error-handling routine may be performed. Otherwise, if the entity executes the section of program code without encountering an interfering memory access or an error condition, the entity commits the transaction, which includes committing the held transactional operations/results (writes, state changes, etc.) to an architectural state of the computing device—thereby making the results of the held transactional operations accessible to and usable by other entities on the computing device.

In such computing devices, in order to prevent transactional results from being accessible to and usable by other entities during a transaction, a read-after-write event during the transaction is treated as an interfering memory access and will therefore cause an entity to abort a transaction or stall a reading entity. More specifically, when another entity (a “reading entity”) reads from a cache block that was previously written during a transaction (i.e., while the transaction is still occurring), the transaction is aborted or the reading entity is stalled until the transaction is completed. Because either the transaction is restarted (or the abortion of the transaction otherwise handled) or the reading entity is stalled, handling transactions in this way can cause inefficient operation of the computing device.

### BRIEF DESCRIPTION OF THE FIGURES

FIG. 1 presents a block diagram illustrating a computing device in accordance with some embodiments.

FIG. 2 presents a block diagram illustrating a cache and a cache controller in accordance with some embodiments.

FIG. 3 presents a block diagram illustrating a cache block in accordance with some embodiments.

FIG. 4 presents pseudocode illustrating interactions between entities during transactions in accordance with some embodiments.

FIG. 5 presents pseudocode illustrating interactions between entities during transactions in accordance with some embodiments.

FIG. 6 presents pseudocode illustrating interactions between entities during a transaction in accordance with some embodiments.

FIG. 7 presents a flowchart illustrating a process for handling a read of a cache block following a transactional write of the cache block during a transaction in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

### Terminology

In the following description, various terms may be used for describing embodiments. The following section provides a simplified and general description of some of these terms. Note that some or all of the terms may have significant additional aspects that are not recited herein for clarity and brevity and thus these descriptions are not intended to limit the terms.

Entities: entities include any portion of the hardware in a computing device and/or software executing on a computing device that can perform the operations herein described. For example, entities can include, but are not limited to, one or more processors, one or more cores (CPU cores, APU cores, GPU cores, etc.), and/or one or more threads executing on the computing device, or some combination thereof.

Architectural state: the architectural state of a processor, a computing device, etc. includes data and information held in the processor, computing device, etc. that may be used by entities in the processor, computing device, etc. (accessed, read, overwritten, modified, etc.). Generally, the data and information comprises any type(s) of data and information held in the processor, computing device, etc. that can be used by entities, such as data stored in memories and/or caches, data stored in registers, state information (flags, values, indicators, etc.), etc. When a result of an operation is “committed” to the architectural state, the result is made accessible to and thus usable by entities in the computing device.

Hardware transactional memory: in some embodiments, hardware transactional memory is implemented by enabling entities in a computing device to execute sections of program code in “transactions,” during which program code is executed normally, but transactional operations/results are prevented from being made accessible to and usable by other entities on the computing device. For example, memory accesses (reads and writes) are allowed during transactions, but transactional memory writes may be prevented from being committed to one or more levels of a memory hierarchy in the computing device during the transaction, thereby rendering the written data inaccessible by other entities in the computing device. During transactions, memory accesses from other entities are monitored to determine if a memory access from another entity interferes with a transactional memory access (e.g., if another of the entities writes data to a memory location read during the transaction, etc.) and transactional operations are monitored to ensure that an error condition has not occurred. If an interfering memory access or an error condition is detected during the transaction, the transaction is aborted, a pre-transactional state of the entity is restored, and the entity may retry the transaction by re-executing the section of program code in another transaction and/or some error-handling routine may be performed. Otherwise, if the entity executes the section of program code without encountering an interfering memory access or an error condition, the entity commits the transaction, which includes committing transactional operations/results (memory writes, state changes, etc.) to an architectural state of the computing device—thereby making the results of the held transactional operations accessible to and usable by other entities on the computing device. Note that, as described in more detail below, the described embodiments use a preserved pre-transactional state of a cache block to avoid aborting a transaction for certain read-after-write cases.

Cache block: a cache block includes any separately accessible (i.e., readable, writeable, etc.) portion of memory circuits in a cache. For example, a cache block can include, but is not limited to, one or more bytes, a cache line, and/or a combination of two or more cache lines.

### Overview

In the described embodiments, an entity in a computing device executes program code in a transaction. During the transaction, the entity writes transactional data to a cache block in a cache. When the entity writes the data to the cache block, the computing device preserves a pre-transactional state of the cache block. For example, the computing device may store a copy of the cache block in the pre-transactional state (i.e., with pre-transactional data) in another memory location before the transactional data is written to the cache block. As another example, the computing device may allow the transactional data to be written to cache blocks in one or more higher-level caches, but may not change the pre-transactional state of the cache block in one or more lower-level caches. The computing device then responds to a read requests for the cache block from other entities in the computing device during the transaction using the preserved pre-transactional state for the cache block. For example, the computing device may respond to read requests for the cache block using the stored copy of the cache block in the pre-transactional state. As another example, the computing device may respond to read requests for the cache block using the copy of the cache block in the pre-transactional state from a lower-level cache.

In some embodiments, before writing the transactional data to the cache block, the entity acquires write permission for the cache block. For example, the entity may use cache coherency mechanisms to request write permission for the cache block. In these embodiments, before responding to a read request for cache block during the transaction, the computing device releases write permission for the cache block to enable an the requesting entity to acquire read permission for the cache block. When write permission is released, the computing device records an identifier for the cache block. The computing device then subsequently uses the identifier to attempt to reacquire write permission for the cache block. For example, the computing device may wait for a predetermined delay and then attempt to reacquire write permission for the cache block. If write permission is successfully reacquired for the cache block, the entity may complete/commit the transaction (assuming that no other condition prevents the transaction from committing). Otherwise, if write permission is not reacquired, the entity aborts the transaction.

By responding to read requests using the preserved pre-transactional state for the cache block, these embodiments enable entities to continue transactions in a situation where transactions would be aborted for entities in existing computing devices. These embodiments thereby enable entities to complete more useful computational work, which in turn improves the performance of the computing device.

### Computing Device

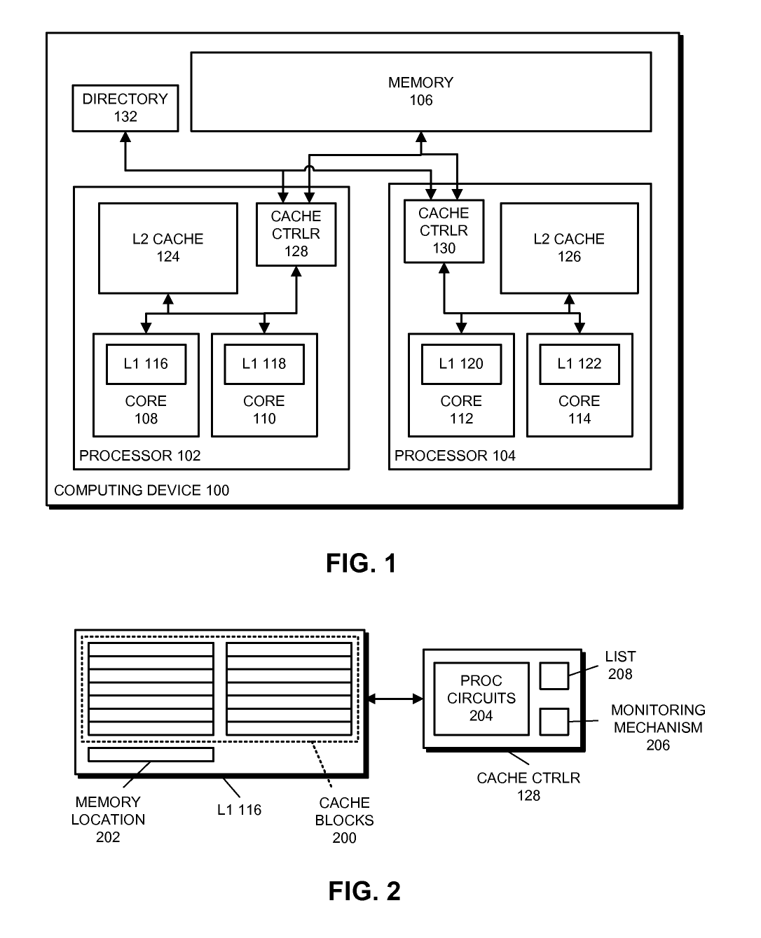

FIG. 1 presents a block diagram illustrating a computing device 100 in accordance with some embodiments. As can be seen in FIG. 1, computing device 100 includes processors 102-104. Processors 102-104 are functional blocks that are configured to perform computational operations in computing device 100. Processors 102-104 include four cores 108-114, each of which comprises a computational mechanism such as a CPU core, a GPU core, an APU core, an application-specific integrated circuit (ASIC), a microcontroller, a programmable logic device, and/or an embedded processor.

Processors 102-104 also include cache memories (or “caches”) that can be used for storing instructions and data that are used by cores 108-114 for performing computational operations. The caches in processors 102-104 include a level-one (L1) cache 116-122 (e.g., “L1 116”) in each core 108-114 that is used for storing instructions and data for use by the corresponding core. Generally, L1 caches 116-122 are the smallest of a set of caches in computing device 100 and are located closest to the circuits (e.g., execution units, instruction fetch units, etc.) in the respective cores 108-114. The closeness of the L1 caches 116-122 to the corresponding circuits enables the fastest access to the instructions and data stored in the L1 caches 116-122 from among the caches in computing device 100.

Processors 102-104 further include level-two (L2) caches 124-126 that are shared by cores 108-110 and 112-114, respectively, and hence are used for storing instructions and data for all of the sharing cores. Generally, L2 caches 124-126 are larger than L1 caches 116-122 and are located outside, but close to, cores 108-114 on the same semiconductor die as cores 108-114. Because L2 caches 124-126 are located outside the corresponding cores 108-114, but on the same die, access to the instructions and data stored in L2 cache 124-126 is slower than accesses to the L1 caches.

Each of the L1 caches 116-122 and L2 caches 124-126, (collectively, “the caches”) include memory circuits that are used for storing data and instructions. For example, the caches can include one or more of static random access memory (SRAM), embedded dynamic random access memory (eDRAM), DRAM, double data rate synchronous DRAM (DDR SDRAM), and/or other types of memory circuits.

As can also be seen in FIG. 1, computing device 100 includes memory 106. Memory 106 comprises memory circuits that form a “main memory” of computing device 100. Memory 106 is used for storing instructions and data for use by the cores 108-114 on processor 102-104. In some embodiments, memory 106 is larger than the caches in computing device 100 and is fabricated from memory circuits such as one or more of DRAM, SRAM, DDR SDRAM, and/or other types of memory circuits.

Taken together, L1 caches 116-122, L2 caches 124-126, and memory 106 form a “memory hierarchy” for computing device 100. Each of the caches and memory 106 are regarded as levels of the memory hierarchy, with the lower levels including the larger caches and memory 106. Thus, the highest level in the memory hierarchy includes L1 caches 116-122.

In addition to processors 102-104 and memory 106, computing device 100 includes directory 132. In some embodiments, cores 108-114 may operate on the same data (e.g., may load and locally modify data from the same locations in memory 106). Computing device 100 generally uses directory 132 and/or another coherency mechanism such as cache controllers 128-130 to avoid different caches and/or memory 106 holding copies of data in different states—i.e., to keep data in computing device 100 “coherent.” Directory 132 is a functional block that includes mechanisms for keeping track of cache blocks/data that are held in the caches, along with the coherency state in which the cache blocks are held in the caches (e.g., using the MESI coherency states modified, exclusive, shared, invalid, and/or other coherency states).

In some embodiments, as cache blocks are loaded from memory 106 into one of the caches in computing device 100 and/or as a coherency state of the cache block is changed in a given cache, directory 132 updates a corresponding record to indicate that the data is held by the holding cache, the coherency state in which the cache block is held by the cache, and/or possibly other information about the cache block (e.g., number of sharers, timestamps, etc.). When a core or cache subsequently wishes to retrieve data or update the coherency state of a cache block held in a cache, the core or cache checks with directory 132 to determine if the data should be loaded from memory 106 or another cache and/or if the coherency state of a cache block can be changed.

As can further be seen in FIG. 1, processors 102-104 include cache controllers 128-130 (“cache ctrlr”), respectively. Each cache controller 128-130 is a functional block with mechanisms for handling accesses to memory 106 and communications with directory 132 from the corresponding processor 102-104.

Although an embodiment is described with a particular arrangement of processors and cores, some embodiments include a different number and/or arrangement of processors and/or cores. For example, some embodiments have two, six, eight, or another number of cores—with the memory hierarchy adjusted accordingly. Generally, the described embodiments can use any arrangement of processors and/or cores that can perform the operations herein described.

Additionally, although an embodiment is described with a particular arrangement of caches and directory 132, some embodiments include a different number and/or arrangement of caches and/or do not include directory 132. For example, the caches (e.g., L1 caches 116-122, etc.) can be divided into separate instruction and data caches. Additionally, L2 cache 124 may not be shared in the same way as shown, and hence may only be used by a single core, two cores, etc. (and hence there may be multiple L2 caches 124 in each processor 102-104). As another example, some embodiments include different levels of caches, from only one level of cache to multiple levels of caches, and these caches can be located in processors 102-104 and/or external to processor 102-104. For instance, some embodiments include one or more L3 caches (not shown) in the processors or outside the processors that is used for storing data and instructions for the processors. As yet another example, in some embodiments, directory 132 is not present and the caches and/or cache controllers 128 and 130 perform coherence operations by communicating with one another. Generally, the described embodiments can use any arrangement of caches that can perform the operations herein described.

Moreover, although computing device 100 and processors 102-104 are simplified for illustrative purposes, in some embodiments, computing device 100 and/or processors 102-104 include additional mechanisms for performing the operations herein described and other operations. For example, computing device 100 and/or processors 102-104 can include processor registers, power controllers, mass-storage devices such as disk drives or large semiconductor memories (as part of the memory hierarchy), batteries, media processors, input-output mechanisms, communication mechanisms, networking mechanisms, display mechanisms, etc.

FIG. 2 presents a block diagram illustrating L1 cache 116 and cache controller 128 in accordance with some embodiments. As can be seen in FIG. 2, L1 cache 116 includes cache blocks 200 and memory location 202. Cache blocks 200 in L1 cache 116 comprise memory circuits used for holding cache blocks (i.e., one or more bytes, cache lines, etc.).

Memory location 202 includes memory circuits used for holding a copy of a cache block in a pre-transactional state. In some embodiments, memory location 202 is used to hold a copy of a cache block that has had transactional data written to it during a transaction. As described herein, keeping the copy of the cache block enables core 108 to provide the copy of the cache block in the pre-transactional state to entities in computing device 100 that subsequently request read permission for the cache block during the transaction.

Note that memory location 202 is an example of a memory location in which the copy of the cache block in the pre-transactional state may be held, in some embodiments, the copy of the cache block in the pre-transactional state is held in a different location (e.g., an available cache block in cache blocks 200 or a memory location in a different portion of computing device 100). In addition, in some embodiments, memory location 202 is not used and thus may not be present in L1 cache 116. Instead, cache controller 128 may permit transactional data to be written to cache blocks in one or more higher-level caches such as L1 cache 116, but may not change the pre-transactional state of the cache block in one or more lower-level caches such as L2 cache 124. In these embodiments, the cache block in the lower-level cache (which holds the pre-transactional state) may be used instead of a copy kept in a memory location such as memory location 202.

As also seen in FIG. 2, cache controller 128 includes processing circuits (“proc circuits”) 204, monitoring mechanism 206, and list 208. Processing circuits 204 is a functional block that handles accesses to memory 106 and communications with directory 132 from processor 102.

List 208 comprises memory circuits that are used by cache controller 128 for recording identifiers for one or more cache blocks for which write permission was released as described herein. The identifiers in list 208 are used to reacquire write permission for corresponding cache blocks. Generally, the identifier includes sufficient information to enable reacquiring write permission for the cache block. For example, in some embodiments, the identifier includes some or all of an address for the cache block.

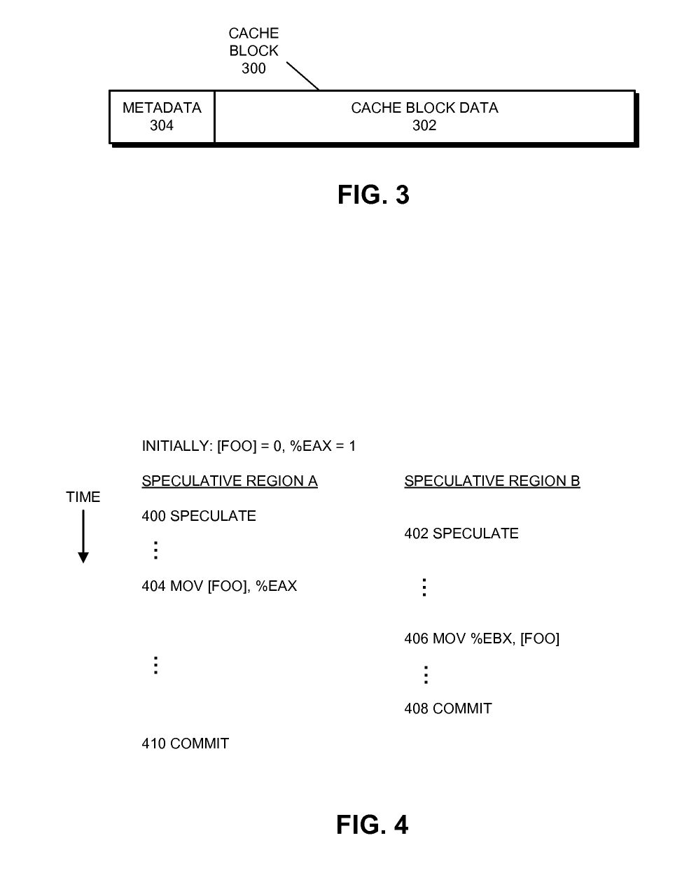

Although list 208 is presented as an example of a record of identifiers for cache blocks for which write permission is to be reacquired, in some embodiments, a different type of record is used. Thus, list 208 may not be present in cache controller 128. For example, in some embodiments, cache blocks are associated with metadata that is used as the record of cache blocks for which write permission is to be reacquired. FIG. 3 presents a block diagram illustrating a cache block 300 in accordance with some embodiments. As can be seen in FIG. 3, cache block 300 includes cache block data 302 and metadata 304. Cache block data 302 holds the data in the cache blocks (e.g., one or more bytes of data, cache lines, etc.). Metadata 304 holds information about the cache block such as valid bits, coherency state bits, transactional read/write bits, and/or other information that can be used by cache controller 128 and other functional blocks for performing operations with cache block 300. In addition, in some embodiments, metadata 304 includes a reacquire indicator (e.g., bit) that is set to indicate that write permission should be reacquired for the cache block.

Monitoring mechanism 206 is a functional block that is configured to perform operations for providing copies of cache blocks in a pre-transactional state to reading entities during transactions after the cache blocks have transactional data written to them during the transaction. Generally, these operations may include some or all the operations herein described. For example, in some embodiments, monitoring mechanism 206 detects when transactional data is to be written to a cache block by an entity executing a transaction and preserves a copy of the cache block in a pre-transactional state. As another example, in some embodiments, monitoring mechanism 206 monitors for incoming read requests for cache blocks that were previously written during a transaction (i.e., as the transaction is in progress). When such a read request is detected, monitoring mechanism 206 releases write permission for the cache block and provides a copy of the cache block in the pre-transactional state to the requesting entity. As yet another example, in some embodiments, monitoring mechanism 206 performs operations for reacquiring write permission for cache blocks for which write permission was previously released.

Although monitoring mechanism 206 is presented as a separate element in cache controller 128, in some embodiments, some or all of monitoring mechanism is located elsewhere in computing device 100 (e.g., in a cache, in a core, in processing circuits 204, etc.). In addition, in some embodiments, some or all of the operations herein described are performed by elements elsewhere in computing device 100.

Although L1 cache 116 and cache controller 128 are presented with certain elements, in some embodiments, one or both of L1 cache 116 and cache controller 128 include different elements. Generally, L1 cache 116 and cache controller 128 (and computing device 100) include sufficient elements to perform the operations herein described. In addition, although presented using L1 cache 116 and cache controller 128, in some embodiments, some or all of L1 caches 118-122 and/or cache controller 130 may include similar internal arrangements.

Interactions between Entities during a Transaction

FIGS. 4-6 present pseudocode illustrating interactions between entities during transactions in accordance with some embodiments. Note that the operations shown in FIGS. 4-6 are presented as a general example of functions performed by some embodiments. The operations performed by other embodiments include different operations and/or operations that are performed in a different order. Additionally, although certain mechanisms (entities in computing device 100, etc.) are used in describing the process, in some embodiments, other mechanisms may perform the operations.

For each of FIGS. 4-6, time advances from the top of the figure to the bottom of the figure. In addition, for each of the examples in FIGS. 4-6, the memory location at exemplary address “FOO” initially holds 0 and processor register EAX (“% EAX”) initially holds 1. This means that entities that read FOO should read 0 and entities that read EAX should read 1. Thus, using the terms used elsewhere in this description, a pre-transactional state (before the transactions shown in FIGS. 4-6) for a cache block that contains address FOO would include a 0 at address FOO. Moreover, speculative regions A and/or B and the non-speculative instructions are simplified to show pseudocode instructions that are useful for explaining the example. However, the speculative regions and/or the non-speculative instructions include other instructions, as represented by ellipses in FIGS. 4-6.

As can be seen in FIG. 4, at time 400, a first entity in processor 102 (core 108 for this example) executes a SPECULATE instruction from speculative region A, thereby starting a first transaction (i.e., causing core 108 to treat the remaining pseudocode as being executed during a transaction). At time 402, a second entity in processor 102 (core 110 for this example) executes a SPECULATE instruction from speculative region B, thereby starting a second transaction.

At time 404, core 108 transactionally executes a MOV instruction, which causes core 108 to store a copy of the contents of register EAX into the memory location at address FOO. To enable performing this operation, core 108 loads a cache block that includes address FOO into L1 cache 116 with write permission (i.e., uses coherency mechanisms such as directory 132 to acquire write permission for the cache block) and then writes the 1 from EAX to the cache block at address FOO.

Because core 108 writes to the cache block during a transaction, processor 102 (e.g., monitoring mechanism 206) preserves a copy of the cache block in a pre-transactional state, i.e., a copy of the cache block in which address FOO holds a 0. For example, processor 102 may store a copy of the cache block in the pre-transactional state in memory location such as memory location 202 before writing to the cache block. As another example, processor 102 may allow the cache block to be written in L1 cache 116, but may prevent the pre-transactional state of the cache block from being overwritten in L2 cache 124.

At time 406, core 110 transactionally executes the MOV instruction, which causes core 110 to read data from the memory location at address FOO and load the data into register EBX. To perform this operation, core 110 loads a cache block that includes address FOO into L1 cache 118 (i.e., uses coherency mechanisms such as directory 132 to acquire read permission for the cache block) and then reads the data from the cache block at address FOO. Because core 108 holds the cache block with write permission (and core 108 is therefore assumed to hold the most recent copy of the cache block), loading the cache block into L1 cache 118 includes retrieving the cache block from core 108. Core 110 therefore sends a read request for the cache block to cache controller 128. In response to the request, processor 102 (e.g., monitoring mechanism 206) releases write permission for the cache block and sends the copy of the cache block in the pre-transactional state (i.e., with a 0 at address FOO) to core 110 to be read as described. For example, in embodiments where processor 102 stores a copy of the cache block in the pre-transactional state in another memory location, processor 102 may retrieve the copy of the cache block in the pre-transactional state from the other memory location and send the retrieved copy. As another example, in embodiments where processor 102 allows the cache block to be written in L1 cache 116, but prevents the pre-transactional state of the cache block from being overwritten in L2 cache 124, processor 102 may cause the copy of the cache block held in L2 cache 124 to be sent.

Despite sending the copy of the cache block in the pre-transactional state to core 110, processor 102 keeps the modified copy of the cache block in L1 cache 116 for use during the transaction (and core 108 continues executing the transaction, accessing the cache block as the transaction dictates). However, processor 102 does not send the modified copy of the cache block from L1 cache 116 to core 110, thereby ensuring that core 110 does not have access to transactional data during the transaction.

At time 408, core 110 executes the COMMIT instruction, which causes core 110 to commit the transaction for speculative region B. When the transaction is committed, transactional results (writes, state changes, etc.) are used to modify/update the architectural state of processor 102—thereby making the results of transactional operations accessible to and usable by core 108 and other entities in computing device 100.

Next, after core 110 commits the transaction, processor 102 (e.g., monitoring mechanism 206) reacquires write permission for the cache block. In some embodiments, when releasing write permission, processor 102 records an identifier for the cache block. Processor 102 then monitors the transaction for core 110 and then attempts to reacquire write permission for the identified cache block after core 110 completes the transaction.

At time 410, core 108 executes the COMMIT instruction, which causes core 108 to commit the transaction for speculative region A. As described above, when the transaction is committed, transactional results (writes, state changes, etc.) are used to modify/update the architectural state of processor 102 (and, more broadly, computing device 100). Because processor 102 reacquired write permission for the cache block, core 108 can update the cache block in L2 cache 124 and/or other levels of the memory hierarchy as the transaction is committed. However, if processor 102 is/was unable to reacquire write permission for the cache block before the transaction commits, core 108 may abort the transaction.

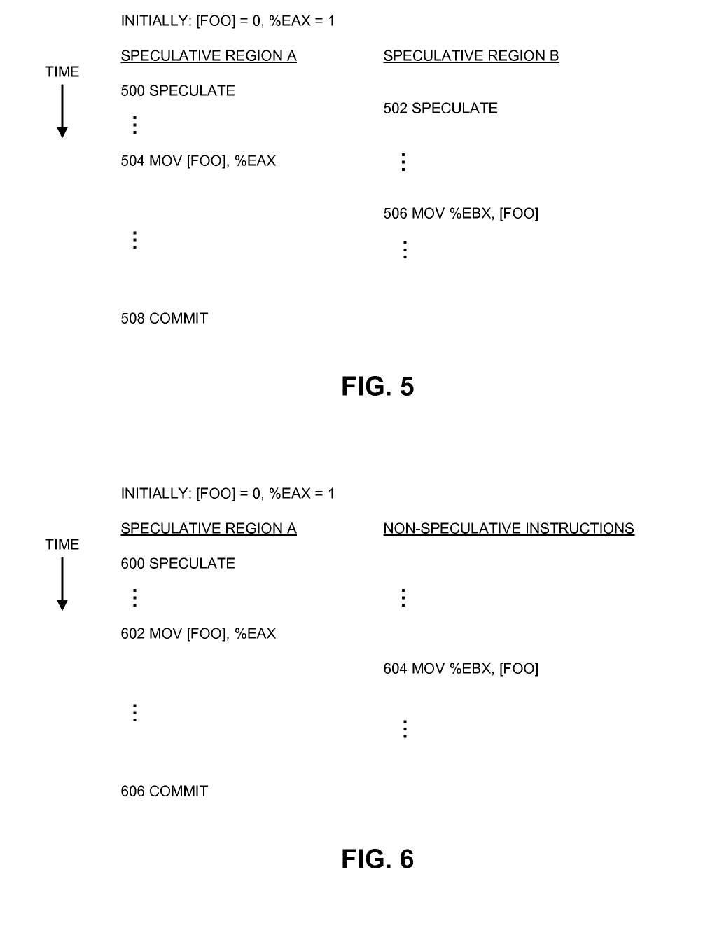

The example shown in FIG. 5 is similar to the example shown in FIG. 4. Thus, the operations performed by the first speculative entity (core 108 in this example) when executing the SPECULATE instruction at time 500, the MOV instruction at time 504, and the COMMIT instruction at time 508 and the operations performed by the second speculative entity (core 110 in this example) when executing the SPECULATE instruction at time 502 and the MOV instruction at time 506 are similar to the operations described above.

However, the example shown in FIG. 5 differs from that shown in FIG. 4 in that a COMMIT instruction is not executed in speculative region B before the COMMIT instruction is executed in speculative region A. This causes core 110 to abort the transaction for speculative region B due to a write-after-read conflict for the cache block. The write-after-read conflict occurs because core 110 loads the cache block that includes address FOO into L1 cache 118 and reads data from the cache block, which means that the subsequent reacquisition of write permission for the cache block by core 108 (treated as a write of the cache block by core 110) is an interfering memory access that causes the transaction for core 110 to fail. (Note that the described embodiments can avoid failing transactions in the presence of a read-after-write conflict using the preserved pre-transactional state of cache blocks, but do not avoid the write-after-read conflict.)

For the example shown in FIG. 6, speculative region A is similar to the example shown in FIG. 4. Thus, the operations performed by the first speculative entity (core 108 in this example) when executing the SPECULATE instruction at time 600 and the MOV instruction at time 602 are similar to the operations described above.

For the non-speculative instructions, when executing the MOV instruction at time 604, the second entity (core 110 in this example) loads a cache block that includes address FOO into L1 cache 118 and then reads the data from the cache block at address FOO. Because core 108 holds the cache block with write permission (as acquired when executing the MOV instruction at time 602), loading the cache block into L1 cache 118 includes retrieving the cache block from core 108. Core 110 therefore sends a read request for the cache block to cache controller 128. In response to the request, processor 102 (e.g., monitoring mechanism 206) releases write permission for the cache block and sends the copy of the cache block in the pre-transactional state (i.e., with a 0 at address FOO) to core 110 to be read (recall that the copy of the cache block in the pre-transactional state is preserved by processor 102 when executing the MOV instruction at time 602).

Despite sending the copy of the cache block in the pre-transactional state to core 110, processor 102 keeps the modified copy of the cache block in L1 cache 116 for use during the transaction (and core 108 continues executing the transaction, accessing the cache block as the transaction dictates). However, processor 102 does not send the modified copy of the cache block from L1 cache 116 to core 110, thereby ensuring that core 110 does not have access to transactional data during the transaction.

After releasing write permission for the cache block, processor 102 (e.g., monitoring mechanism 206) reacquires write permission for the cache block. In some embodiments, when releasing write permission, processor 102 records an identifier for the cache block. Because core 110 is not executing a transaction as in FIG. 4, processor 102 waits a predetermined time after releasing write permission before reacquiring write permission using the recorded identifier. Generally, the predetermined time is a time estimated to be sufficient for core 110 to perform at least one read of the cache block. In some embodiments, the predetermined time is a set time, although, in some embodiments, the predetermined time may be adjusted (e.g., based on an average time for reacquiring write permission, etc.).

At time 606, core 108 executes the COMMIT instruction, which causes core 108 to commit the transaction for speculative region A. As described above, when the transaction is committed, transactional results (writes, state changes, etc.) are used to modify/update the architectural state of processor 102 (and, more broadly, computing device 100). Because processor 102 reacquired write permission for the cache block, core 108 can update the cache block in L2 cache 124 and/or other levels of the memory hierarchy as the transaction is committed. However, if processor 102 is/was unable to reacquire write permission for the cache block before the transaction commits, core 108 may abort the transaction.

As shown in FIG. 6, the described embodiments can avoid aborting a transaction following a non-transactional read of a transactionally written cache block using the preserved pre-transactional state of the cache block. However, although not shown in the examples in FIGS. 4-6, should a non-speculatively executed instruction (e.g., a MOV instruction) write to a speculatively written cache block during a transaction, the transaction is aborted.

### Process for Handling a Read of a Cache Block Following a Transactional Write of the Cache Block

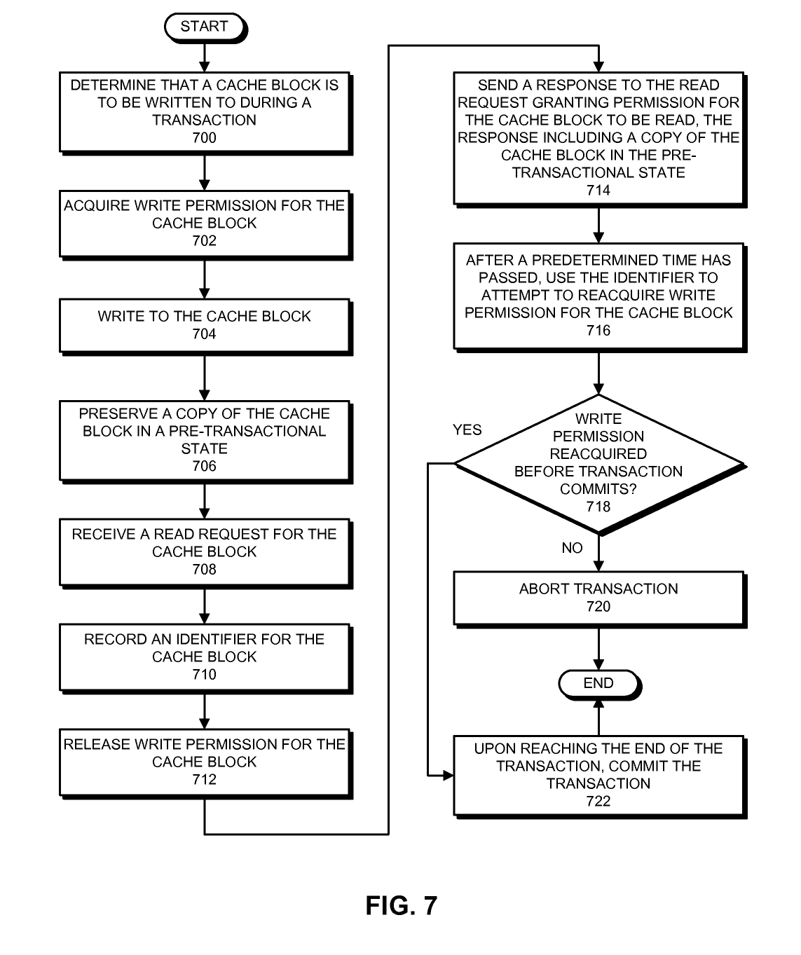

FIG. 7 presents a flowchart illustrating a process for handling a read of a cache block following a transactional write of the cache block during a transaction in accordance with some embodiments. More specifically, in FIG. 7, a process is shown in which processor 102 responds to a read request for a cache block during a transaction using a copy of the cache block in a pre-transactional state after an entity (core 108) has written transactional data to the cache block. In these embodiments, the copy of the cache block in the pre-transactional state includes the data that was stored in the cache block before transactional data was written to the cache block during the transaction.

As described above, an entity can include any hardware portion of a processor and/or software executing on a processor that can perform the operations shown in FIG. 7. For example, the entity may be any of processors 102-104, cores 108-114, a thread on any of cores 108-114, etc. However, in the description of FIG. 7, core 108 is used as the entity that writes transactional data to the cache block during a transaction and core 110 is used as an entity that sends a read request for the cache block.

Note that the operations shown in FIG. 7 are presented as a general example of functions performed by some embodiments. The operations performed by other embodiments include different operations and/or operations that are performed in a different order. Additionally, although certain mechanisms (entities in computing device 100, etc.) are used in describing the process, in some embodiments, other mechanisms can perform the operations. Moreover, for the example in FIG. 7, core 108 executes a transaction and core 110 does not. In this case, the reacquisition of write permission by core 108 may be handled differently than if core 110 is also executing a transaction. Handling the reacquisition of write permission when core 110 is also executing a transaction is shown in FIGS. 4-5 and described above.

The process shown in FIG. 7 starts when core 108 determines that a cache block is to be written during a transaction (step 700). For example, a store instruction executed in core 108 may cause core 108 to determine that data is to be written to the cache block.

Core 108 then acquires write permission for the cache block (step 702). For example, in embodiments that include directory 132, core 108 may send a request to directory 132 to acquire write permission for the cache block. Directory 132 may then cause any other entities in computing device 100 to give up read or write permission for the cache block (e.g., directory 132 may send messages to the entities that cause the entities to invalidate any local copies of the cache block) and then respond to core 108 granting core 108 write permission for the cache block. As another example, in embodiments where directory 132 is not present in computing device 100, core 108 may send a request to one or more other entities requesting write permission for the cache block. In response to the request, the other entities may invalidate local copies of the cache block and then respond to core 108, the responses indicating that core 108 has write permission for the cache block.

After acquiring write permission for the cache block, core 108 writes to the cache block (step 704). In this operation, core 108 modifies data in some or all of the cache block using data from a transactional operation (or “transactional data”), thereby altering a pre-transactional state of the cache block. As described above, the operations shown in FIG. 7 occur during a transaction for core 108. Thus, transactional data that is to be prevented from effecting the architectural state of computing device 100 is written to the cache block. In other words, until the transaction is committed, the data written to the cache block in step 704 is not to be made accessible to and usable by other entities in computing device 100.

When core 108 writes to the cache block, processor 102 (e.g., monitoring mechanism 206) preserves a copy of the cache block in a pre-transactional state (step 706). Generally, the preservation action may include any type(s) of operations that cause the pre-transactional state of the cache block to be retained for future operations. For example, processor 102 may store a copy of the cache block in the pre-transactional state (i.e., with pre-transactional data) in a memory location such as memory location 202 before writing to the cache block. As another example, processor 102 may allow the transactional data to be written to cache blocks in one or more higher-level caches such as L1 cache 116, but may prevent the change of the pre-transactional state of the cache block in one or more lower-level caches such as L2 cache 124.

During the transaction (i.e., as core 108 is still performing operations that are part of the transaction), processor 102 (e.g., cache controller 128) receives a read request from core 110 for the cache block (step 708). As described above, depending on the embodiment, the read request may be received from directory 132 on behalf of core 110 or from core 110 directly.

Processor 102 then records an identifier for the cache block (step 710). The identifier for the cache block is to be used to reacquire write permission for the cache block for core 108. In some embodiments, when recording the identifier, processor 102 records some or all of an address for the cache block into a dedicated memory location, a list such as list 208, and/or other record. As another example, in some embodiments, processor 102 updates metadata for the cache block such as metadata 304. In these embodiments, this update may include updating a reacquire indicator in the metadata for the cache block (e.g., from “0” to “1”).

Processor 102 next releases write permission for the cache block (step 716). For example, core 108 may update metadata for the cache block to indicate that core 108 no longer has write permission for the cache block.

Processor 102 then sends a response to the read request to core 110 granting permission for the cache block to be read, the response including a copy of the cache block in the pre-transactional state (step 714). As described above, depending on the embodiment, the response may be sent to directory 132 on behalf of core 110 or sent to core 110 directly.

Generally, because core 108 has write permission for the cache block, sending the response to the read request includes sending data from the cache block to core 110. In some embodiments, because write permission for the cache block was acquired during a transaction and/or because core 108 has written data to the cache block during the transaction (i.e., in step 704), processor 102 sends the preserved copy of the cache block in the pre-transactional state with the response. For example, in embodiments where processor 102 stores a copy of the cache block in the pre-transactional state in another memory location such as memory location 202, processor 102 may retrieve the copy of the cache block in the pre-transactional state from the other memory location and send the retrieved copy with the response. As another example, in embodiments where processor 102 writes the transactional data to cache blocks in one or more higher-level caches such as L1 cache 116, but does not change the pre-transactional state of the cache block in one or more lower-level caches such as L2 cache 124, instead of responding with a copy of the cache block from L1 cache 116, processor 102 may cause the copy of the cache block held in L2 cache 124 to be sent with the response.

Note that, in some embodiments, although responding with the copy of the cache block in the pre-transactional state, processor 102 retains the cache block with the transactional data in L1 cache 116 and/or in another location. Retaining the cache block in this way enables core 108 to continue executing the transaction, accessing the cache block in L1 cache 116 as the transaction dictates. However, as described below, core 108 should eventually reacquire write permission for the cache block in order for the transaction to be committed.

Next, after a predetermined time has passed, processor 102 uses the recorded identifier for the cache block to attempt to reacquire write permission for the cache block (step 716). Attempting to reacquire write permission for the cache block includes performing operations similar to the operations for initially acquiring write permission (as described above for step 702). Generally, the predetermined time is a time estimated to be sufficient for core 110 to perform at least one read of the cache block. In some embodiments, the predetermined time is a set time, although, in some embodiments, the predetermined time may be adjusted (e.g., based on an average time for reacquiring write permission, etc.).

In some embodiments, processor 102 may attempt to reacquire write permission two or more times. For example, processor 102 may attempt to reacquire write permission after the predetermined time, as the transaction commits, and/or one or more other times. This may include repeatedly attempting to acquire write permission until write permission is acquired or the transaction commits. In some embodiments, processor 102 only attempts to reacquire write permission for the cache block as core 108 is to commit the transaction (i.e., the predetermined time is the time at which the transaction is committed).

If write permission is not reacquired before core 108 is to commit the transaction (step 718), core 108 aborts the transaction (step 720). Note that the transaction is aborted because the copy of the cache block with transactional data in L1 cache 116 cannot be written/committed to the architectural state of processor 102 until write permission (which was released in step 712) is held for the cache block.

Otherwise, if write permission is reacquired (step 718), upon reaching the end of the transaction, core 108 commits the transaction (step 722). When a transaction is committed, transactional results (writes, state changes, etc.) are used to modify/update the architectural state of processor 102—thereby making the results of transactional operations accessible to and usable by core 110 and other entities in computing device 100.

### Handling Contention for Cache Blocks

If there is contention from readers (i.e., if one or more entities are reading from one or more cache blocks), it is possible that write permission will need to be repeatedly reacquired for one or more cache blocks, possibly preventing the successful commitment of a transaction. Some embodiments handle this situation by placing a limit on the number of times that write permission will be reacquired for a particular cache block and/or placing a limit on the number of times that write permission will be reacquired during the transaction, regardless of the particular cache block(s) for which write permission is reacquired. In these embodiments, the transaction is aborted when the limit is exceeded. Some embodiments handle this situation by stalling responses to read requests (thereby stalling the reading entity) to enable the transaction to commit.

### Initial Acquisition of Write Permission

In some embodiments, a similar operation to the operation described above is used to delay the initial acquisition of write permission for a transactional write. For example, during a transaction, a cache block may be written in a higher-level cache such as L1 cache 116 without first acquiring write permission for the cache block. However, the transactional data is kept in the higher-level cache and not propagated to the lower-level cache such as L2 cache 124 (thereby preserving the pre-transactional state of the cache block in the higher-level cache to enable aborting the transaction). When the transactional data is written to the higher-level cache, an identifier for the cache block is added to a list such as list 208 and/or metadata such as metadata 304 may then be updated to indicate that write permission should be acquired for the cache block. Write permission is then subsequently acquired for the cache block using the recorded identifier. For example, write permission may be acquired for the cache block as late as when the transaction commits, or anytime in between the transactional write and when the transaction commits. In these embodiments, if write permission is acquired, the transaction commits normally. Otherwise, the transaction aborts. In some embodiments, computing device 100 includes one or more mechanisms to determine when write permission should be acquired using this technique.

In some embodiments, a computing device (e.g., computing device 100 in FIG. 1) uses code and/or data stored on a computer-readable storage medium to perform some or all of the operations herein described. More specifically, the computing device reads the code and/or data from the computer-readable storage medium and executes the code and/or uses the data when performing the described operations.

A computer-readable storage medium can be any device or medium or combination thereof that stores code and/or data for use by a computing device. For example, the computer-readable storage medium can include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/cores/central processing units (CPUs), application-specific integrated circuit (ASIC) chips, field-programmable gate arrays (FPGAs), caches/cache controllers, embedded processors, graphics processors (GPUs)/graphics cores, pipelines, Accelerated Processing Units (APUs), and/or other programmable-logic devices. When such hardware modules are activated, the hardware modules perform some or all of the operations. In some embodiments, the hardware modules include one or more general-purpose circuits that are configured by executing instructions (program code, firmware, etc.) to perform the operations.

In some embodiments, a data structure representative of some or all of the structures and mechanisms described herein (e.g., computing device 100 and/or some portion thereof) is stored on a computer-readable storage medium that includes a database or other data structure which can be read by a computing device and used, directly or indirectly, to fabricate hardware comprising the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates/circuit elements from a synthesis library that represent the functionality of the hardware comprising the above-described structures and mechanisms. The netlist may then be placed and routed to produce a data set describing geometric shapes to be applied to masks. The masks may then be used in various semiconductor fabrication steps to produce a semiconductor circuit or circuits corresponding to the above-described structures and mechanisms. Alternatively, the database on the computer accessible storage medium may be the netlist (with or without the synthesis library) or the data set, as desired, or Graphic Data System (GDS) II data.

In the following description, functional blocks may be referred to in describing some embodiments. Generally, functional blocks include one or more interrelated circuits that perform the described operations. In some embodiments, the circuits in a functional block include circuits that execute program code (e.g., machine code, firmware, etc.) to perform the described operations.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for handling cache blocks during a transaction in a computing device, comprising:
in a processor, performing operations for:
after a first entity writes to a cache block in a cache during the transaction, responding to a read request for the cache block from a second entity with a copy of the cache block in a pre-transactional state; and
continuing the transaction for the first entity after responding to the read request.

2. The method of claim 1, further comprising:
when the first entity writes to the cache block in the cache during the transaction, permitting the first entity to write to the cache block in a higher-level cache, and leaving the cache block in a lower-level cache in the pre-transactional state; and
when responding to the read request for the cache block with the copy of the cache block in the pre-transactional state, using the cache block from the lower-level cache to respond to the read request.

3. The method of claim 1, further comprising:
before the first entity writes to the cache block during the transaction, storing the copy of the cache block in the pre-transactional state in a separate memory location; and
when responding to the read request for the cache block with the copy of the cache block in the pre-transactional state, using the stored copy of the cache block in the pre-transactional state from the separate memory location to respond to the read request.

4. The method of claim 1, further comprising:
acquiring write permission for the cache block before writing to the cache block in the cache;
releasing write permission for the cache block when responding to the read request for the cache block with the copy of the cache block in the pre-transactional state; and
subsequently reacquiring write permission for the cache block.

5. The method of claim 4, further comprising:
recording an identifier for the cache block when releasing write permission for the cache block; and
at a predetermined time, using the identifier to reacquire write permission for the cache block.

6. The method of claim 5, wherein recording the identifier for the cache block when releasing write permission for the cache block comprises one of:
recording the identifier for the cache block in a list, the list comprising a record of cache blocks for which write permission is to be reacquired; or setting metadata in the cache block, the metadata indicating that write permission is to be reacquired for the cache block.

7. The method of claim 4, further comprising:
aborting the transaction for the first entity when write permission cannot be reacquired for the cache block before the transaction is to commit.

8. The method of claim 1, wherein the copy of the cache block in the pre-transactional state comprises data that was present in the cache block before transactional data was written to the cache block during the transaction.

9. An apparatus that handles cache blocks during a transaction, comprising:
a processor; and
a cache in the processor, the cache comprising a plurality of cache blocks used for storing data for the processor;
wherein the processor is configured to:
after a first entity writes to a cache block in the cache during the transaction, respond to a read request for the cache block from a second entity with a copy of the cache block in a pre-transactional state; and
continue the transaction for the first entity after responding to the read request.

10. The apparatus of claim 9, wherein the processor is further configured to:
when the first entity writes to the cache block in the cache during the transaction, permit the first entity to write to the cache block in a higher-level cache, and leave the cache block in a lower-level cache in the pre-transactional state; and
when responding to the read request for the cache block with the copy of the cache block in the pre-transactional state, use the cache block from the lower-level cache to respond to the read request.

11. The apparatus of claim 9, wherein the processor is further configured to:
before the first entity writes to the cache block during the transaction, store the copy of the cache block in the pre-transactional state in a separate memory location; and
when responding to the read request for the cache block with the copy of the cache block in the pre-transactional state, use the stored copy of the cache block in the pre-transactional state from the separate memory location to respond to the read request.

12. The apparatus of claim 9, wherein the processor is further configured to:
acquire write permission for the cache block before writing to the cache block in the cache;
release write permission for the cache block when responding to the read request for the cache block with the copy of the cache block in the pre-transactional state; and
subsequently reacquire write permission for the cache block.

13. The apparatus of claim 12, wherein the processor is further configured to:
record an identifier for the cache block when releasing write permission for the cache block; and
when reacquiring write permission for the cache block, the processor is configured to use the identifier to reacquire write permission for the cache block.

14. The apparatus of claim 12, wherein the processor is configured to:
abort the transaction for the first entity when write permission cannot be reacquired for the cache block before the transaction is to commit.

15. A computing device that handles cache blocks during a transaction, comprising:
a processor;
a cache in the processor, the cache comprising a plurality of cache blocks used for storing data for the processor; and
a memory coupled to the processor, the memory configured to store instructions and data for the processor;
wherein the processor is configured to:
after a first entity writes to a cache block in the cache during the transaction, respond to a read request for the cache block from a second entity with a copy of the cache block in a pre-transactional state; and
continue the transaction for the first entity after responding to the read request.

16. The computing device of claim 15, wherein the processor is further configured to:
when the first entity writes to the cache block in the cache during the transaction, permit the first entity to write to the cache block in a higher-level cache, and leave the cache block in a lower-level cache in the pre-transactional state; and
when responding to the read request for the cache block with the copy of the cache block in the pre-transactional state, use the cache block from the lower-level cache to respond to the read request.

17. The computing device of claim 15, wherein the processor is further configured to:
before the first entity writes to the cache block during the transaction, store the copy of the cache block in the pre-transactional state in a separate memory location; and
when responding to the read request for the cache block with the copy of the cache block in the pre-transactional state, use the stored copy of the cache block in the pre-transactional state from the separate memory location to respond to the read request.

18. The computing device of claim 15, wherein the processor is further configured to:
acquire write permission for the cache block before writing to the cache block in the cache;
release write permission for the cache block when responding to the read request for the cache block with the copy of the cache block in the pre-transactional state; and
subsequently reacquire write permission for the cache block.

19. The computing device of claim 18, wherein the processor is further configured to:
record an identifier for the cache block when releasing write permission for the cache block; and
when reacquiring write permission for the cache block, the processor is configured to use the identifier to reacquire write permission for the cache block.

20. The computing device of claim 18, wherein the processor is configured to:
abort the transaction for the first entity when write permission cannot be reacquired for the cache block before the transaction is to commit.
